(19) United States
(12) Patent Application Publication
(10) Pub. No.: US 2007/0197198 A1
(43) Pub. Date: Aug. 23, 2007

(54) Push-to-all (PTA) service system and method of providing additional information

(76) Inventor: Jin-Suk Lee, Suwon-si (KR)

Correspondence Address: Robert E. Bushnell;Suite 300, 1522 K Street, N.W., Washington, DC, 20005-1202, US

(21) Appl. No.: 11/523,580

(22) Filed: Sep. 20, 2006

(30) Foreign Application Priority Data
Feb. 17, 2006 (KR) 10-2006-0015843

(51) Int. Cl. H04Q 7/22; H04Q 7/38

(52) U.S. Cl. 455/414.1

(57) ABSTRACT

A Push-To-All (PTA) service system and method provides additional information. A PTA server provided with the additional information of a PTA terminal having the floor in a session from the corresponding PTA terminal through a TBCP_REQUEST message provides the additional information to other PTA terminals participating in the session through a TBCP_TAKEN message. The other PTA terminals are thereby provided with various pieces of information about the PTA terminal having the floor.

### CLAIM OF PRIORITY

This application makes reference to, incorporates the same herein, and claims all benefits accruing under 35 U.S.C.§119 from an application for SYSTEM AND METHOD FOR THE PTA SYSTEM SERVING ADDITIONAL INFORMATION earlier filed in the Korean Intellectual Property Office on the 17^{th} of February 2006 and there duly assigned Serial No. 10-2006-0015843.

### BACKGROUND OF THE INVENTION

1. Field of the Invention

The present invention relates to a Push-To-All (PTA) service system and a method of providing additional information.

2. Description of the Related Art

A Push-To-All (PTA) service is an Internet Protocol (IP) Multimedia Subsystem (IPMS)-based service, which includes a Push-To-Talk (PTT) service, a Push-To-Video (PTV) service, a Message Session Relay Protocol (MSRP) service, and so on. The PTT service is for transmitting voice data. The PTV service is for transmitting image data. The MSRP service is for transmitting text messages or binary data.

Data transmission for the PTA service is performed through a session. In the PTA service, at least three PTA terminals can participate in one session to be provided with a group service. The PTA terminals participating in the same session can hear the same conversation or receive the same data.

The PTA terminal intending to be provided with the PTA service first establishes a PTA session with a correspondent PTA terminal using an INVITE message of the Session Initiation Protocol (SIP) INVITE method. Then, the PTA terminal can request or release the floor (right to speak) in the established PTA session using a Floor Control Protocol (FCP). During the PTA session, the data can be transmitted and received in such a manner that the PTA terminal is granted the floor, and then transmits the data, or receives the data that is transmitted by another PTA terminal to which the floor is given. At this time, the transmitted and received data can include all of the voice data, the image data, the text messages, binary data, and so on.

The floor is managed by a PTA server. When requested for the floor by any PTA terminal, the PTA server determines whether or not the floor is granted to the corresponding PTA terminal. According to the result of the determination, the PTA server can grant the floor to the corresponding PTA terminal, or deny the request for the floor of the corresponding PTA terminal. Furthermore, when granting the floor to any PTA terminal, the PTA server notifies the other PTA terminals participating in the session as the corresponding PTA terminal that the floor is granted to the corresponding PTA terminal. To this end, the PTA server can use a Talk Burst Control Protocol (TBCP)_TAKEN message.

Under certain circumstances, PTA terminals not having the floor can require information about the PTA terminal having the floor. For example, a PTA terminal not having the floor is aware of a floor time permitted to the PTA terminal having the floor, and can thereby determine when it is effective to request the floor.

The information of the PTA terminal having the floor can be included in the TBCP_TAKEN message. However, in the case of an existing TBCP_TAKEN message, only information on a Uniform Resource Identifier (URI), as a Canonical NAME (CNAME), of the PTA granted the floor is included. In other words, among the information of the PTA terminal having the floor, only the CNAME information is provided to the other PTA terminals within the session. In the case of the PTV service, the moving picture of a speaker (i.e., a person II having the floor) is provided. However, in this case, the quantity of provided information is also insufficient. Accordingly, there is need for a means capable of providing other information in addition to the CNAME information of the PTA terminal having the floor in a session to the other PTA terminals participating in the session.

### SUMMARY OF THE INVENTION

It is, therefore, an object of the present invention to provide a Push-To-All (PTA) service system and a method of providing additional information of a PTA terminal having the floor in a session to other PTA terminals participating in the session.

According to one aspect of the present invention, a Push-To-All (PTA) service system is provided including: a first PTA terminal adapted to have the floor in a session; a second PTA terminal adapted to participate in the same session as the first PTA terminal; and a PTA server adapted to provide additional information of the first PTA terminal to the second PTA terminal.

The first PTA terminal is preferably adapted to provide the additional information of the first PTA terminal to the PTA server. The first PTA terminal is preferably adapted to provide the additional information thereof to the PTA server using a TBCP_REQUEST message. The first PTA terminal is preferably adapted to request the floor using the TBCP_REQUEST message.

The PTA server is preferably adapted to pre-store the additional information of the first PTA terminal.

The first PTA terminal is preferably adapted to provide the pre-stored information to the PTA server using a TBCP_REQUEST message.

The additional information of the first PTA terminal preferably includes at least one of: information on a user of the first PTA terminal, an available floor time of the first PTA terminal, a speech agenda of the first PTA terminal, a message input by the user of the first PTA terminal, a web site address, and image data. The available floor time of the first PTA terminal is preferably extra floor time permitted to the first PTA terminal. The available floor time of the first PTA terminal is preferably equal to a default floor time limit set in the PTA server minus a time for which the first PTA terminal has had the floor. The available floor time of the first PTA terminal is preferably equal to a floor time allotted to the first PTA terminal by the PTA server minus a time for which the first PTA terminal has had the floor. The PTA server is preferably adapted to provide the additional information of the first PTA terminal to the second PTA terminal using a TBCP_TAKEN message.

According to another aspect of the present invention, a Push-To-All (PTA) service method is provided including: a first PTA terminal taking the floor in a session; a second PTA terminal participating in the same session as the first PTA terminal; and a PTA server providing additional information of the first PTA terminal having the floor in a session to the second PTA terminal participating in the session same session as the first PTA terminal.

The method preferably further includes the first PTA terminal providing the additional information thereof to the PTA server. The first PTA terminal preferably provides the additional information thereof to the PTA server in response to the first PTA terminal requesting the floor. The first PTA terminal preferably provides the additional information thereof to the PTA server using a TBCP_REQUEST message.

The method preferably further includes the PTA server storing the additional information of the first PTA terminal provided by the PTA terminal.

The PTA server preferably provides the additional information of the first PTA terminal to the second PTA terminal using a TBCP_TAKEN message.

The additional information of the first PTA terminal preferably includes at least one of: information on a user of the first PTA terminal, an available floor time of the first PTA terminal, a speech agenda of the first PTA terminal, a message input by the user of the first PTA terminal, a web site address, and image data.

As described above, the PTA service system and method of providing additional information are characterized in that the PTA server provided with the additional information of the PTA terminal having the floor in a session by the corresponding PTA terminal through a TBCP_REQUEST message provides the additional information to the other PTA terminals participating in the session using a TBCP_TAKEN message.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of the configuration of a Push-To-All (PTA) system;

FIG. 2 is a view of the format of a TBCP_REQUEST message according to an embodiment of the present invention;

FIG. 3 is a view of the format of a TBCP_GRANT message according to an embodiment of the present invention;

FIG. 4 is a view of the format of a TBCP_TAKEN message according to an embodiment of the present invention;

FIG. 5 is a view of the format of a TBCP_DENY message according to an embodiment of the present invention; and

FIGS. 6, 7,8, 9, 10, and 11 are views of formats of a TBCP_REQUEST message and a TBCP_TAKEN message according to exemplary embodiments of the present invention.

### DETAILED DESCRIPTION OF THE INVENTION

Hereinafter, the present invention is described below in more detail with reference to the accompanying drawings, in which exemplary embodiments of the invention are shown. In the drawings, like reference numbers and symbols refer to like elements throughout the specification. To enable a clear understanding of the present invention, related technology that is well known to those of ordinary skill in the art to which the present invention pertains have not been described in detail.

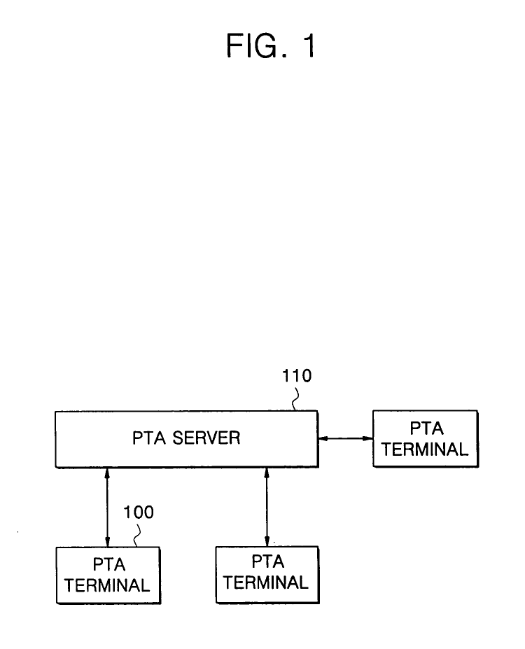

FIG. 1 is a view of the configuration of a Push-To-All (PTA) system, in which a plurality of PTA terminals are connected to a PTA server.

As illustrated in FIG. 1, the PTA system comprises at least one PTA terminal 100 and a PTA server 110.

The PTA terminal 100 is used by a PTA service user to receive a PTA service, and has a PTA client and a PTA service requester contained therein. All requests of the PTA service user are transmitted to the PTA system including the PTA server 110 through the PTA terminal 100, and their responses are transmitted to the PTA service user through the PTA terminal 100. Hence, the PTA service user will not be separately described below. As long as no precise distinction is required, the term “PTA terminal 100” is used to refer both to the terminal itself and the PTA service user.

The PTA terminal 100 makes it possible to access a PTA service. The PTA terminal 100 serves mainly to create a new PTA session, participate in an existing PTA session that has been already created, and terminate a created PTA session. In addition, the PTA terminal 100 can serve to create and deliver a talk burst, perform authentication when providing access to the PTA service, and so on.

The PTA server 110 can maintain and manage the PTA session. For example, the PTA server 110 can manage the floor in each session. When the floor is requested by any PTA terminal 100, the PTA server 110 determines whether or not to assign the floor to the corresponding PTA terminal 100. According to a result of the determination, the PTA server 110 can assign the floor to the corresponding PTA terminal 100, or deny the request for the floor of the corresponding PTA terminal 100. Furthermore, the PTA server 110 can control data transmission between the PTA terminals 100 that are participating in the session. In other words, the PTA server 110 can transmit the talk burst received from the PTA terminal 100 having the floor to the other PTA terminals 100 participating in the session.

As illustrated in FIG. 1, the PTA system can have a server-client structure formed by the PTA terminal 100 and the PTA server. The PTA system in which the plurality of PTA terminals 100 are connected to one PTA server 110, as illustrated in FIG. 1, is merely an example to aid in understanding the present invention. PTA systems to which the present invention can be applied are not limited to the example illustrated in FIG. 1. For example, the present invention can be applied to a PTA system in which different PTA servers 110 are connected to each other through a network, for example, and connected to the PTA terminals 100.

In the PTA system, signaling can be carried out through Session Initiation Protocol (SIP), a signaling protocol. For example, a PTA session can be set up by using an SIP INVITE method. SIP is a text-based application level protocol which operates on a server-client model. Due to its simple structure and excellent expandability compared to existing protocols, SIP is used in various fields such as Internet telephony, video telephony, multimedia, on-line game connections, and so on.

In the PTA system, data can be transmitted by a Talk Burst Control Protocol (TBCP) message. The TBCP message can be used to transmit various data including media data such as image data, voice data, and so on. The TBCP message can be implemented on the basis of an RTP Transport Control Protocol (RTCP) Application packet (RTCP:APP), which is defined in RFC 3550.

Particularly, a TBCP_REQUEST message used by the PTA terminal 100 to request the floor can be used to transmit additional information of the PTA terminal 100 to the PTA server 110. The TBCP-REQUEST message can be transmitted to the PTA server 110 by the PTA terminal 100 that has the floor or intends to get the floor. In other words, not all the PTA terminals 100 transmitting the TBCP_REQUEST message have the floor. However, without distinguishing between the two cases herein, it is assumed that all the PTA terminals 100 transmitting the TBCP_REQUEST message according to the present invention are “the PTA terminal having the floor.”

The TBCP message that can be used for the present invention is described below with reference to the accompanying drawings. A format of each TBCP message suggested below is based on the RTCP:APP, which is defined in RFC 3550.

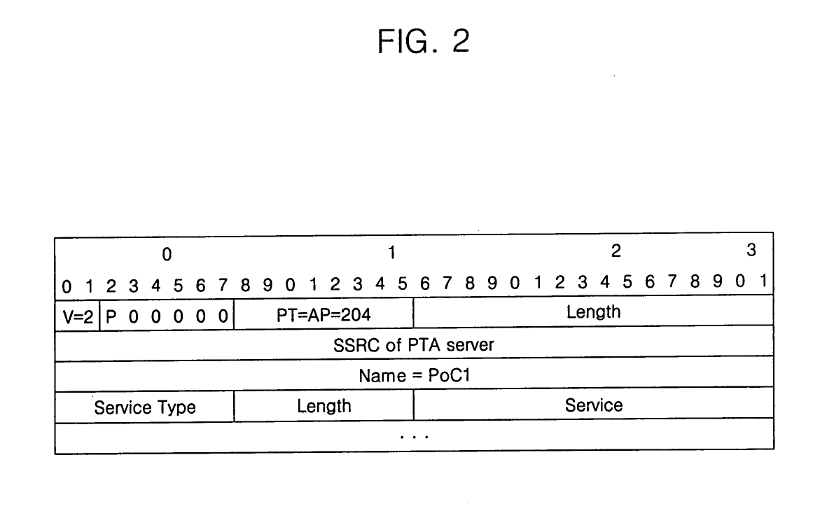

FIGS. 2, 3, 4, and 5 are views of general formats of TBCP messages available for the present invention.

FIG. 2 illustrates the format of a TBCP_REQUEST message.

The TBCP_REQUEST message can contain a 2-bit Version field, a 1-bit Padding field, a 5-bit Subtype field, a 1-byte Payload Type (PT) field, a 2-byte Length field, a 4-byte SSRC (Synchronization SouRCe) field, a NAME field, and an Application Information field.

The Version field includes RTP version information of the corresponding TBCP message. The TBCP message of FIG. 2 is a message of RTP version 2. The Padding field includes, in the corresponding TBCP message, information as to whether or not a padding octet that does not belong to a payload has been added. The Subtype field contains information on what role of TBCP the corresponding TBCP message plays. The Payload Type field contains information on the purpose for which the corresponding TBCP message is used. For example, “204” represented in FIG. 2 indicates a message indicating that the corresponding TBCP message is used for control. The Length field contains information on a length of the corresponding TBCP message.

The SSRC field contains information for synchronization of data. The NAME field includes information about a system in which the corresponding TBCP message is used. Generally, the NAME field can be expressed by an American Standard Code for Information Interchange (ASCII) value.

The foregoing fields can be equally included in TBCP_GRANT, TBCP_TAKEN, and TBCP_DENY messages, which are described below. Therefore, these fields will not be described again in the future.

The TBCP_REQUEST message for the present invention further includes a Service Type field, a Length field, and a Service field in order to contain the additional information of the PTA terminal 100. The Service Type field can contain information indicating a type of the information included in the corresponding TBCP_REQUEST message. The Length field can contain information indicating a size of the information included in the corresponding TBCP_REQUEST message. The Service field can contain additional information about the corresponding PTA terminal, in which the additional information is provided by the PTA terminal transmitting the corresponding TBCP_REQUEST message.

The following Table 1 shows service types, additional information of the PTA terminal, etc., all of which can be contained in the TBCP_REQUEST message.

TABLE 1

| Service | | | |
|---|---|---|---|
| Type | Service | Example | Description |
| 0x01 | Basic | “John Doe” \| “PTT Session Creator” | Speaker Information |
| | Information | | except CNAME |
| | of Speaker | | |
| 0x02 | Requested | 900 (sec) | Requested Floor |
| | Floor Time | | Time |
| 0x03 | Text Data | “It is the agenda of today's meeting.” | Speech Subject |
| 0x04 | Web URL | “http://www.samsung.com/wibro/intro.html” | URL Push |
| 0x05 | Binary Data | “myicon.jpg” | Photograph of |
| | | | Speaker |
| 0x06 | | | |

Table 1 shows the service types and examples of the detailed additional information of the PTA terminal corresponding to the service types.

The service type 0×01 indicates additional information which the PTA terminal transmitting the corresponding TBCP_REQUEST message intends to provide to other PTA terminals participating in the session in addition to an existing Canonical NAME (CNAME) included in the corresponding TBCP_REQUEST message. An example of the additional information corresponding to the service type 0×01 can include “John Doe”|“PTT Session Creator,” as shown in Table 1. This additional information can be included in the Service field of the TBCP_REQUEST message.

The service type 0×02 is for indicating that the information contained in the Service field is a floor time permitted to the PTA terminal 100 having the floor. The floor time contained in the TBCP_REQUEST message can be requested by the corresponding PTA terminal 100. The PTA server 110 can permit all or part of the floor time requested by the corresponding PTA terminal 100 in reference to a preset floor time limit and so on. The PTA server 110 can include the floor time permitted to the corresponding PTA terminal 100 in the TBCP_GRANT message to be transmitted to the corresponding PTA terminal 100. Furthermore, the PTA server 110 can include information, such as the total floor time, the time elapsed, etc., for the PTA terminal 100 having the floor in the TBCP_DENY message to be transmitted to a PTA terminal 100 that requested the floor and was denied. The PTA terminal 100 receiving the corresponding information can request the floor in reference to that information.

The service type 0×03 corresponds to a message, such as a speech agenda, a speech subject, etc., of which the PTA terminal having the floor wants to inform the other PTA terminals. The service type 0×04 corresponds to information, such as WEB URL, etc., for reference in connection with the speech. The service type 0×05 can be used when a small quantity of image information, for instance a photograph of a user of the PTA terminal having the floor, is provided as additional information. In addition, various service types can be defined for the present invention.

The additional information of the PTA terminal having the floor can be included in the TBCP_REQUEST message to be transmitted to the PTA server 110 to allow other PTA terminals to request the floor.

The PTA server 110 can provide the information provided when the PTA terminal 100 requests the floor to the other PTA terminals 100 participating in the session. The PTA server 110 can store the additional information of each PTA terminal 100 provided by each PTA terminal 100, and then provide the stored additional information of the corresponding PTA terminal 100 to the other PTA terminals 100 whenever the corresponding PTA terminal 100 has the floor. The PTA server 110 can include the information of the PTA terminal 100 having the floor in the TBCP_TAKEN message, which is used to inform the other PTA terminals 100 that the floor is granted to a specific PTA terminal 100, and then provide the TBCP_TAKEN message to the other PTA terminals 100. In addition, the PTA server 110 transmits the TBCP_GRANT message, which informs the PTA terminal 100 requesting the floor that the corresponding request is accepted, to the PTA terminal 100 requesting the floor.

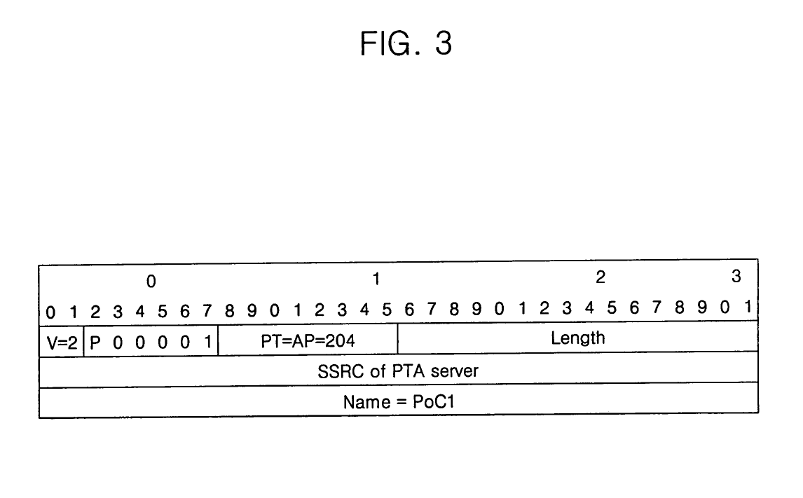

FIG. 3 is a view of the format of a TBCP_GRANT message.

The TBCP_GRANT message is used to inform the PTA terminal 100 requesting the floor that the corresponding request has been accepted. If necessary, the TBCP_GRANT message can include an available floor time assigned to the corresponding PTA terminal 100.

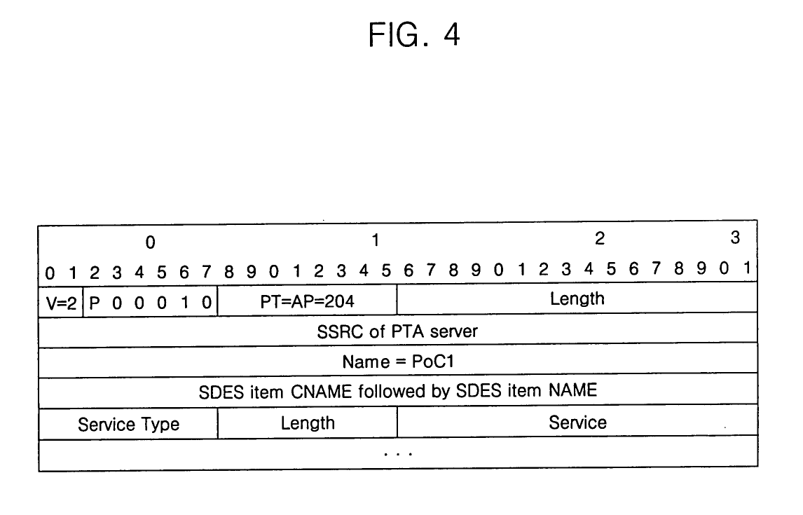

FIG. 4 is a view of the format of a TBCP_TAKEN message.

The TBCP_TAKEN message is used when the PTA server 110 informs the other PTA terminals 100 within a session that the floor has been granted to a specific PTA terminal 100 within the same session. Furthermore, the TBCP_TAKEN message can be used to inform the other PTA terminals 100 of the additional information of the PTA terminal 100 having the floor. Similar to the TBCP_REQUEST message, the TBCP_TAKEN message according to the present invention can include a Service Type field, a Length field, and a Service field. These fields can also contain the contents illustrated in Table 1, as in the TBCP_REQUEST message.

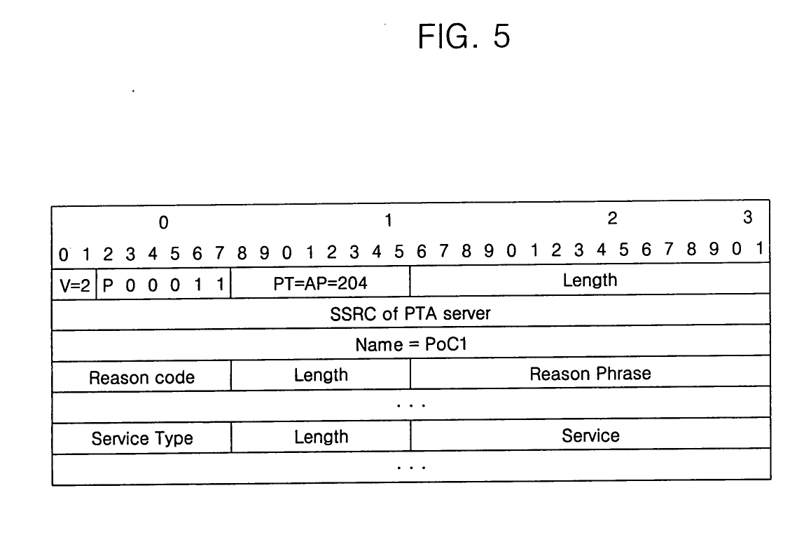

FIG. 5 is a view of the format of a TBCP_DENY message.

The TBCP_DENY message is used to inform the PTA terminal 100 requesting the floor that the corresponding request has been denied. The TBCP_DENY message can include the reason why the floor request has been denied. The most common reason for denial of the floor request of the 100 is that another PTA terminal 100 has the floor in the session. The TBCP_DENY message can include the additional information of the PTA terminal 100 having the floor. An example of the additional information of the PTA terminal 100 having the floor can include information on the floor time permitted to the corresponding PTA terminal 100. The PTA terminal 100 receiving the TBCP_DENY message can use the corresponding information to request the floor in the future. For example, when receiving the TBCP_DENY message informing that the floor time permitted to the PTA terminal 100 having the floor is 100 seconds, the PTA terminal 100 can request the floor again after 100 seconds has elapsed. Thus, the probability of the floor request of the PTA terminal 100 being denied can be reduced.

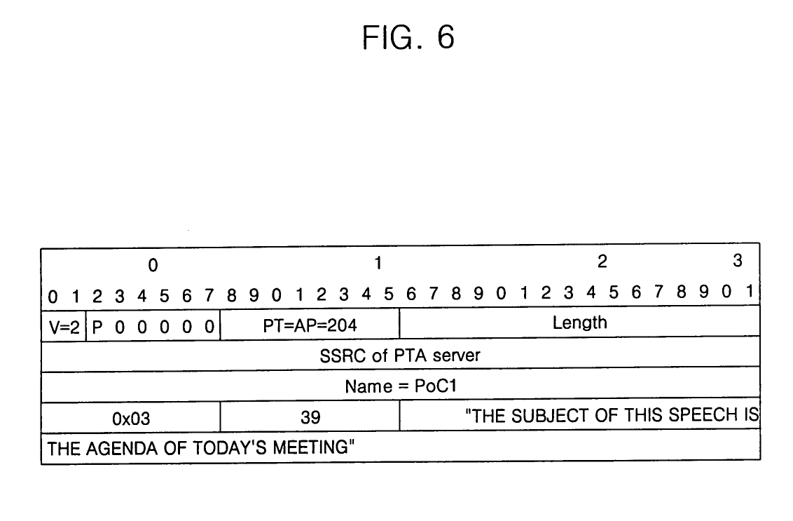

FIGS. 6, 7, 8, 9, 10, and 11 are views of formats of a TBCP_REQUEST message and a TBCP_TAKEN message in accordance with exemplary embodiments of the present invention.

FIG. 6 illustrates a TBCP_REQUEST message, which includes “0×03” in a Service Type field, and “This speech subject is related to agenda of today's meeting” in a Service field. That is, the TBCP_REQUEST message of FIG. 6 can transmit the information “The subject of this speech is the agenda of today's meeting” from the PTA terminal 100 to the PTA server 110.

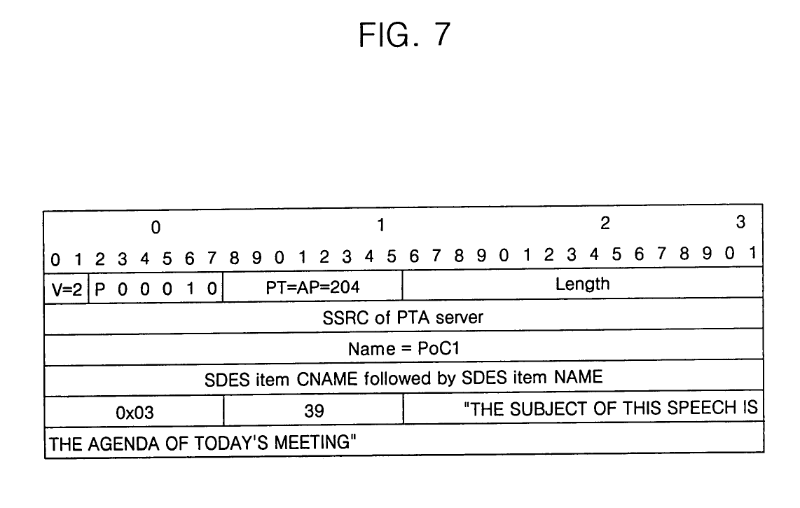

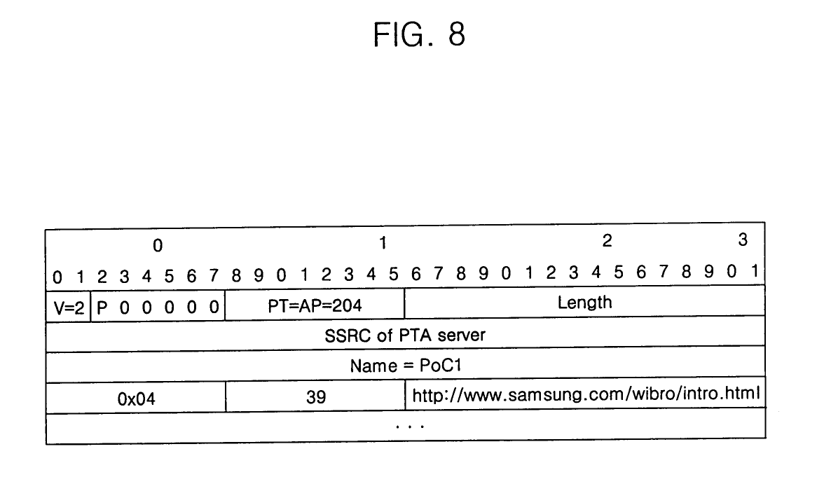

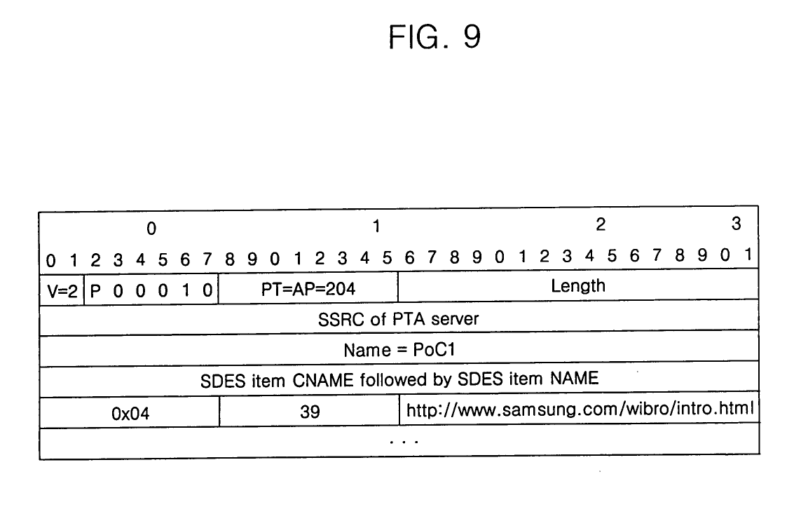

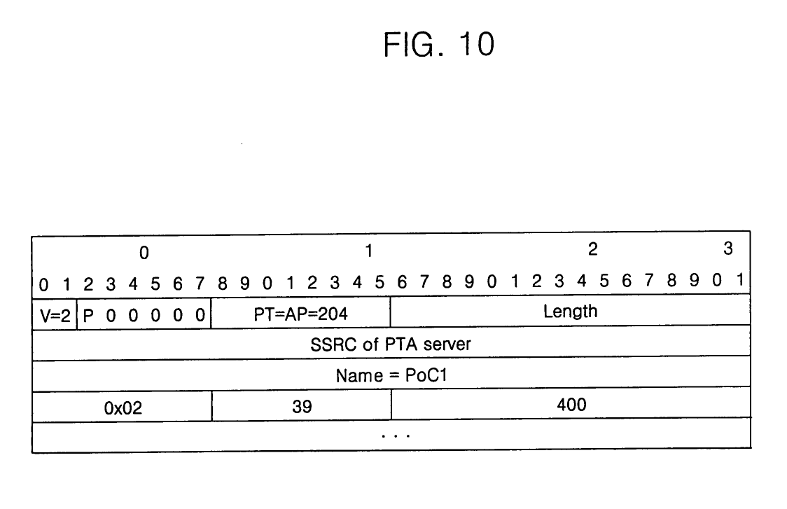

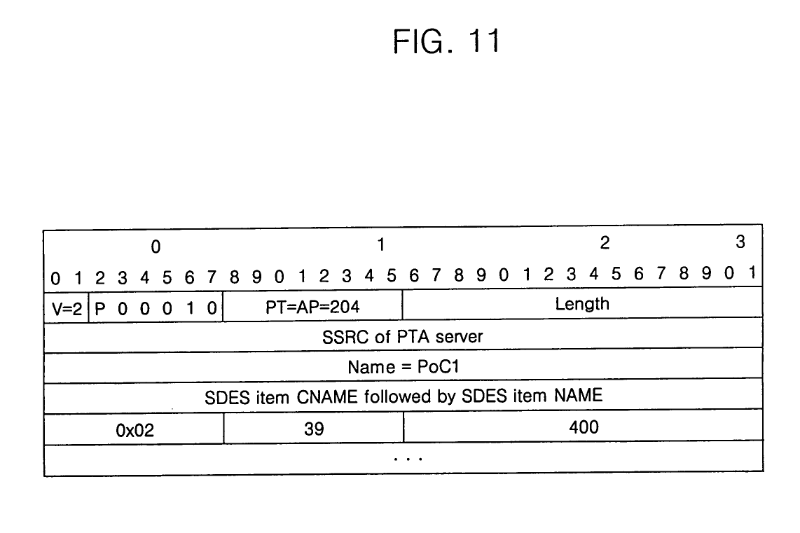

FIG. 7 illustrates a TBCP_TAKEN message, which includes “0×03” in a Service Type field, and “The subject of this speech is the agenda of today's meeting” in a Service field. That is, the TBCP_TAKEN message of FIG. 7 can transmit the information “The subject of this speech is the agenda of today's meeting,” which the PTA terminal 100 having the floor provides, to the PTA terminal 100 not having the floor.

FIGS. 8 and 9 illustrate a TBCP_REQUEST message and a TBCP_TAKEN message, each of which includes “0×04” in a Service Type field, and “http://www.samsung.com/wibro/intro.html” in a Service field.

FIGS. 10 and 11 illustrate a TBCP_REQUEST message and a TBCP_TAKEN message, each of which includes “0×02” in a Service Type field, and “400” in a Service field.

The PTA terminal 100 having the floor can previously register its own information with the PTA server 110, and provide additional information it wants to provide or change to the PTA server 110 whenever it requests the floor.

As described above, according to the present invention, the PTA service system and method of providing additional information provides the additional information of the PTA terminal having the floor in a session to the other PTA terminals 100 participating in the session, thereby providing the other PTA terminals in the session with detailed information on the PTA terminal having the floor. Ultimately, this can enhance the convenience of PTA service users.

While the present invention has been described with reference to exemplary embodiments thereof, it will be understood by those skilled in the art that various modifications in form and detail can be made therein without departing from the scope of the present invention as defined by the following claims.

What is claimed is:

1. A Push-To-All (PTA) service system, comprising:
a first PTA terminal adapted to have the floor in a session;
a second PTA terminal adapted to participate in the same session as the first PTA terminal; and
a PTA server adapted to provide additional information of the first PTA terminal to the second PTA terminal.

2. The system according to claim 1, wherein the first PTA terminal is adapted to provide the additional information of the first PTA terminal to the PTA server.

3. The system according to claim 2, wherein the first PTA terminal is adapted to provide the additional information thereof to the PTA server using a TBCP_REQUEST message.

4. The system according to claim 3, wherein the first PTA terminal is adapted to request the floor using the TBCP_REQUEST message.

5. The system according to claim 1, wherein the PTA server is adapted to pre-store the additional information of the first PTA terminal.

6. The system according to claim 5, wherein the first PTA terminal is adapted to provide the pre-stored information to the PTA server using a TBCP_REQUEST message.

7. The system according to claim 1, wherein the additional information of the first PTA terminal includes at least one of: information on a user of the first PTA terminal, an available floor time of the first PTA terminal, a speech agenda of the first PTA terminal, a message input by the user of the first PTA terminal, a web site address, and image data.

8. The system according to claim 7, wherein the available floor time of the first PTA terminal is extra floor time permitted to the first PTA terminal.

9. The system according to claim 8, wherein the available floor time of the first PTA terminal is equal to a default floor time limit set in the PTA server minus a time for which the first PTA terminal has had the floor.

10. The system according to claim 8, wherein the available floor time of the first PTA terminal is equal to a floor time allotted to the first PTA terminal by the PTA server minus a time for which the first PTA terminal has had the floor.

11. The system according to claim 10, wherein the PTA server is adapted to provide the additional information of the first PTA terminal to the second PTA terminal using a TBCP_TAKEN message.

12. A Push-To-All (PTA) service method, comprising:
a first PTA terminal taking the floor in a session;
a second PTA terminal participating in the same session as the first PTA terminal; and
a PTA server providing additional information of the first PTA terminal having the floor in a session to the second PTA terminal participating in the session same session as the first PTA terminal.

13. The method according to claim 12, further comprising the first PTA terminal providing the additional information thereof to the PTA server.

14. The method according to claim 13, wherein the first PTA terminal provides the additional information thereof to the PTA server in response to the first PTA terminal requesting the floor.

15. The method according to claim 13, wherein the first PTA terminal provides the additional information thereof to the PTA server using a TBCP_REQUEST message.

16. The method according to claim 13, further comprising the PTA server storing the additional information of the first PTA terminal provided by the PTA terminal.

17. The method according to claim 12, wherein the PTA server provides the additional information of the first PTA terminal to the second PTA terminal using a TBCP_TAKEN message.

18. The method according to claim 12, wherein the additional information of the first PTA terminal comprises at least one of: information on a user of the first PTA terminal, an available floor time of the first PTA terminal, a speech agenda of the first PTA terminal, a message input by the user of the first PTA terminal, a web site address, and image data.
